(19) United States
(12) Patent Application Publication
(10) Pub. No.: US 2022/0214515 A1
(43) Pub. Date: Jul. 7, 2022

(54) SELF-ALIGNING CAMERA LENS ASSEMBLY

(71) Applicant: SEKONIX CO., LTD., Gyeonggi-do (KR)

(72) Inventors: Byeong Ha CHOI, Seoul (KR); Hyo Seo JEON, Gyeongsangnam-do (KR); Yang Hee HAN, Seoul (KR); Ji Young CHOI, Gyeonggi-do (KR); Seong Jun BAE, Gyeonggi-do (KR)

(73) Assignee: SEKONIX CO., LTD., Gyeonggi-do (KR)

(21) Appl. No.: 17/567,768

(22) Filed: Jan. 3, 2022

(30) Foreign Application Priority Data
Jan. 6, 2021 (KR) 10-2021-0001170

(51) Int. Cl. G02B 7/00; G02B 7/02

(52) U.S. Cl. CPC G02B 7/003; G02B 7/021

(57) ABSTRACT

A self-aligning camera lens assembly, in which a plurality of lenses is assembled in a lens barrel, includes a front lens having a coupling portion formed outside an effective diameter on a rear surface thereof, and a rear lens positioned behind the front lens, having a coupling groove formed outside an effective diameter on a front surface thereof to be coupled to the coupling portion, and combined with the front lens with optical axes aligned, in which a radius (R) of curvature of the coupling portion of the front lens and an angle (V) of an apex of the coupling groove of the rear lens satisfy R>0.05 mm and 60°<V<120°.

### CROSS REFERENCE TO RELATED APPLICATION

The present application claims priority to Korean Patent Application No. 10-2021-0001170, filed on Jan. 6, 2021, the entire contents of which is incorporated herein for all purposes by this reference.

### BACKGROUND OF THE INVENTION

### Field of the Invention

The present disclosure relates to a camera lens assembly and, more particularly, to a self-aligning camera lens assembly that enables eccentricity adjustment and alignment of optical axes only through the operation of assembling lenses in a lens barrel because optical axes are naturally aligned by the shapes of the lens.

### Description of the Related Art

Recently, as the demands for high image quality, high performance, downsizing, and weight reduction of electronic devices provided a camera function increase, studies for achieving the demands by improving the performance of the microlens optical system are being conducted.

In accordance with the demand for high performance, the number of lenses of the microlens optical system is increasing, and the shape, gap, properties, material, etc. of lenses are adjusted to achieve high performance.

In general, in the microlens optical system, a camera lens assembly is configured by assembling a plurality of lenses upward from an object around an optical axis in a lens barrel, and the alignment of the lenses assembled in the lens barrel is a very important request that determines the quality.

It is necessary to improve precision of a lens barrel in order to achieve more precise alignment. It is also a necessary technical factor to improve the performance of an assembler for assembling lenses in a lens barrel in order to manufacture high-resolution camera lenses in a great quantity.

In particular, the decenter of a single lens and the decenter between lenses are very important technical factors when lenses are assembled in a lens barrel.

Further, tiltering (a phenomenon in which a lens is assembled at an angle) that causes deterioration of resolution is also one of the matters to be solved when lenses are assembled.

FIG. 1 is a cross-sectional view of a camera lens assembly of the related art. The optical characteristics of the entire camera lens system is determined when single lenses L1 to L6 are inserted and assembled in a mechanical lens barrel of the related art.

Miss matching of the optical axes from the lens L1 to the lenses L2˜L6 in this assembled state is a factor that deteriorates the resolution characteristic intended by the designer.

Further, it is difficult to technically overcome this problem due to the characteristics of a lens barrel mold that is limited by mechanical tolerances. Further, there is a need for development and mass production of a camera lens assembly that maintains minimum eccentricity of single lenses that are manufactured in an ultra-precision mold that is machined by a diamond turning machine (DTM) when a lens mold is manufactured.

In the related art, eccentricity of lenses is usually adjusted by the lens barrel in which the lenses are mounted or a specific micro adjuster. As a method that uses a micro adjuster, there is Korean Patent No. 10-0691192, titled “Apparatus for lens adjustment and manufacturing method of lens barrel used the same”.

This related art is composed of: a lens barrel support that supports a lens barrel in which a plurality of lenses is mounted to restrict movement of the lens barrel; a frame that is positioned over the lens barrel support and has a side formed around the outer side of the lens barrel, two or more micro adjusters that are mounted on the side of the frame, adjusts eccentricity of a first lens closest to an object of the plurality of lenses mounted in the lens barrel, and provides pressure to finely adjust the position of the first lens, and a lens adjuster that has one or more elastic members providing elasticity to maintain the position of the first lens moved by the micro adjuster.

According to this related art, specific micro adjuster and elastic members are provided to adjust eccentricity of lenses such that eccentricity of the lenses is adjusted by an external configuration other than the lens barrel. However, there is a defect that since the apparatus is generally complicated, it cannot catch up with the precision of the lenses manufactured by an ultra-precision mold.

### SUMMARY OF THE INVENTION

The present disclosure has made in an effort to solve the problems described above and an objective of the present disclosure is to provide a self-aligning camera lens assembly that enables eccentricity adjustment and alignment of optical axes only through the operation of assembling lenses in a lens barrel because optical axes are naturally aligned by the shapes of the lens.

In order to achieve the objectives, a self-aligning camera lens assembly according to the present disclosure, in which a plurality of lenses is assembled in a lens barrel, includes: a front lens having a coupling portion formed outside an effective diameter on a rear surface thereof; and a rear lens positioned behind the front lens, having a coupling groove formed outside an effective diameter on a front surface thereof to be coupled to the coupling portion, and combined with the front lens with optical axes aligned, in which a radius R of curvature of the coupling portion of the front lens and an angle V of an apex of the coupling groove of the rear lens satisfy R>0.05 mm and 60°<V<120°.

The coupling portion and the coupling groove may be coupled to each other through point contact.

The front lens is a first lens positioned at an object and the rear lens is a second lens positioned behind the first lens, and the self-aligning camera lens assembly may include: a first lens having a first coupling portion outside an effective diameter on a rear surface thereof; and a second lens positioned behind the first lens, having a first coupling groove, which is coupled to the first coupling portion, outside an effective diameter on a front surface thereof and combined with the first lens with optical axes aligned.

The coupling portion of the front lens and the coupling groove of the rear lens may be selectively formed up to a specific lens or may be formed at all lenses, depending on specifications of the camera lens assembly.

The coupling portion of the front lens and the coupling groove of the rear lens each may be formed in a circular annular shape along an outside of an effective diameter or each may be formed at one or more positions along an outside of an effective diameter.

A non-contact region may exist between coupling surfaces of the coupling portion and the coupling groove.

An inner side of the barrel and an outer side of a lens may be fitted to each other such that optical axes are aligned, and a light path blocking film may be inserted between the front lens and the rear lens.

The camera lens assembly may include four to seven lenses.

According to the present disclosure, since the optical axes of lenses are naturally aligned by the shapes of the lenses in the present disclosure, eccentricity is adjusted and optical axes are aligned through only the operation of assembling lenses in a barrel without a specific component for adjusting eccentricity. Accordingly, there is an effect that it is possible to simply align the optical axes of lenses or the optical axis of a single lens.

In particular, since the radius R of curvature of the coupling portion of the front lens and the angle V of the apex of the coupling groove of the rear lens satisfy R>0.05 mm and 60°<V<120°, it is possible to prevent eccentricity of optical axes and tiltering and it is also possible to improve precision of assembly.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a cross-sectional view of a camera lens assembly according to the related art;

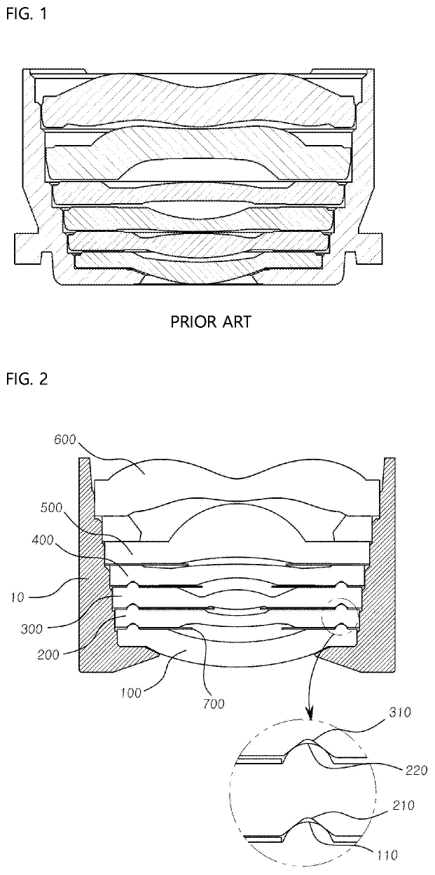

FIG. 2 is a schematic cross-sectional view of a camera lens assembly according to an embodiment of the present disclosure;

FIG. 3 is a schematic enlarged cross-sectional view of main parts shown in FIG. 2;

FIGS. 4 to 7 are schematic views of lenses according to various embodiments of the present disclosure; and

FIGS. 8 to 10 are schematic views showing the shapes of coupling portions formed at a first lens (front lens) according to various embodiments of the present disclosure.

### DETAILED DESCRIPTION OF THE INVENTION

The present disclosure relates to a camera lens assembly in which a plurality of lenses is assembled in a lens barrel in accordance with the demand for high resolution, particularly, to a camera lens assembly that enables self alignment of the optical axes of lenses using the shapes of the lenses.

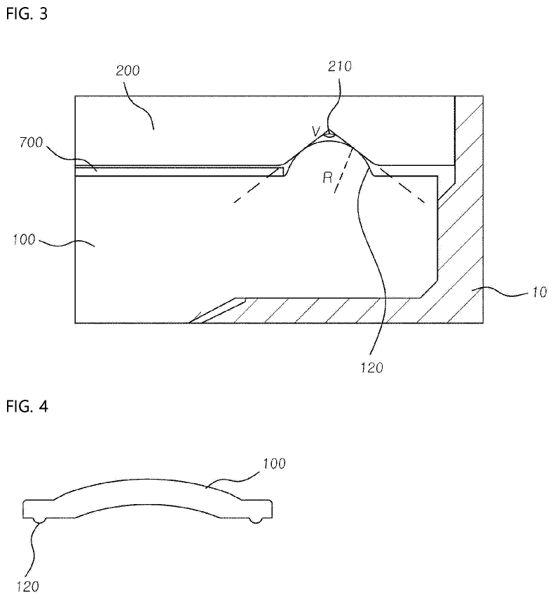

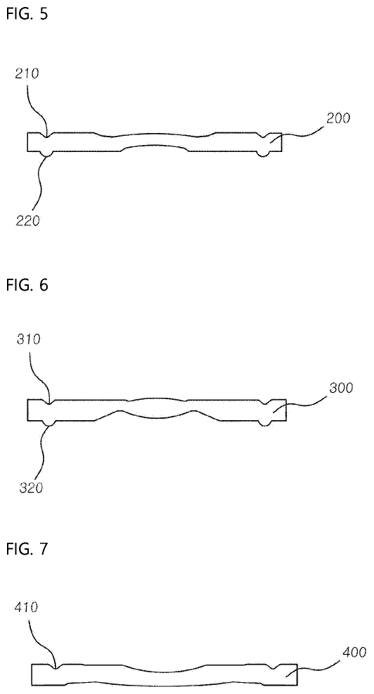

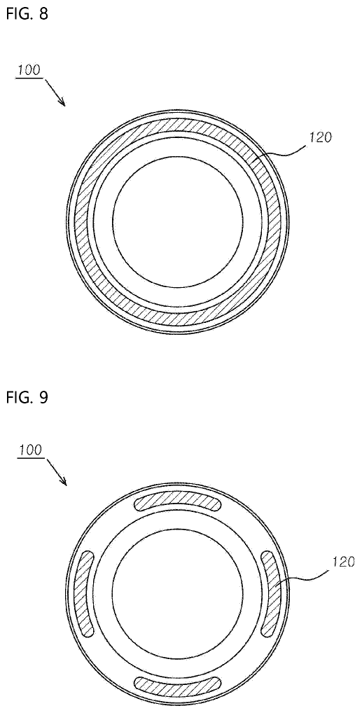

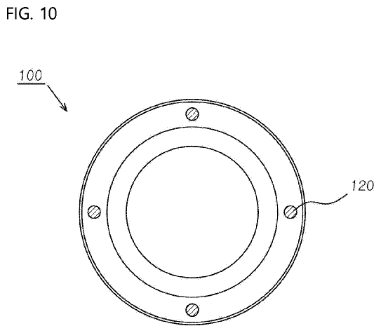

Embodiments of the present disclosure will be described hereafter in detail with reference to the accompanying drawings. FIG. 2 is a schematic cross-sectional view of a camera lens assembly according to an embodiment of the present disclosure, FIG. 3 is a schematic enlarged cross-sectional view of main parts shown in FIG. 2, FIGS. 4 to 7 are schematic views of lenses according to various embodiments of the present disclosure, and FIGS. 8 to 10 are schematic views showing the shapes of coupling portions formed at a first lens (front lens) according to various embodiments of the present disclosure.

As shown in the figures, a self-aligning camera lens assembly according to the present disclosure, in which a plurality of lenses is assembled in a lens barrel 10, includes a front lens having a coupling portion formed outside an effective diameter on the rear surface, and a rear lens positioned behind the front lens, having a coupling groove formed outside an effective diameter on the front surface to be coupled to the coupling portion, and combined with the front lens with the optical axes aligned, in which the radius R of curvature of the coupling portion of the front lens and the angle V of the apex of the coupling groove of the rear lens satisfy R>0.05 mm and 60°<V<120°.

In general, a lens assembly of at least four lenses is required to achieve functions recently requiring high resolution and high performance. Distortion of the lenses is corrected and the aberration is reduced to improve resolution of an optical system. Further, the lenses are non-spherical plastic lenses having a specific shape and refractive power and manufactured by a precisely machined mold to provide a micro camera lens assembly.

According to the camera lens assembly, a plurality of lenses is sequentially inserted and assembled in a mechanically machined lens barrel 10. In particular, according to the present disclosure, the lenses positioned at the front of the lens barrel 10 are machined in a specific shape so that the optical axes between the lenses or the axis of single lenses is naturally aligned by the lenses themselves.

The outer side and the inner side of the lens barrel 10 are machined in specific shapes (electrical discharge machining and injection machining) in accordance with products to be installed. In particular, the inner side of the lens barrel 10 is machined in accordance with the thicknesses and shapes (shapes of the outer sides of flanges) of the lenses so that eccentricity of single lenses or eccentricity between the lenses is primarily prevented and the lenses can be guided when the lenses are assembled.

The lens positioned at the front (an object) in the lens barrel 10 is referred to as a front lens, the lens positioned behind (over) the front lens is referred to as a rear lens, and the lenses assembled in the lens barrel 10 are, sequentially from the front, referred to as a first lens 100, a second lens 200, a third lens 300, a fourth lens 400, a fifth lens 500, a sixth lens 600, a seventh lens, and . . . , in which the lenses are sequentially assembled in the lens barrel 10 from the first lens 100. The camera lens assembly according to an embodiment of the present disclosure includes four to seven lenses.

In general, in a lens assembly having a plurality of lenses, the front lens 100 and the second lens 200 from the front of the lens barrel 10 are most sensitive to eccentricity between lenses. Accordingly, the most important characteristic in an embodiment of the present disclosure is that the shapes of the first lens 100 and the second lens 200 are improved so that their optical axes can be naturally aligned when they are assembled in the lens barrel 10.

The shapes of the first lens 100, the second lens 200, the third lens 300, and the fourth lens 400 may be improved in accordance with the specifications of the camera lens assembly so that the optical axes can be naturally aligned. If necessary, it is possible to improve the shapes of any one pair or lenses adjacent to one pair of the lenses of the lens assembly or all of the lenses of the lens assembly.

The present disclosure, in which the shapes of the lenses are improved, includes a front lens having a coupling portion outside the effective diameter on the rear surface and a rear lens positioned behind the front lens, having a coupling groove, which is coupled to the coupling portion, outside the effective diameter on the front surface, and combined with the front lens with the optical axes aligned.

That is, the front lens and the rear lens are combined with the optical axes aligned by the coupling structures corresponding to each other of the coupling portion of the front lens and the coupling groove of the rear lens adjacent to the coupling portion. Further, coupling structures corresponding to each other are formed outside the effective diameters of the lenses, whereby stress that is applied to the effective diameter regions of the lens is minimized.

The coupling portion of the front lens and the coupling groove of the rear lens are formed in coupling structures corresponding to each other. The shapes of only the first lens 100 and the second lens 200 may be improved in coupling structures corresponding to each other, or even the third lens 300 or the fourth lens 400 may be coupled to each other in coupling structures corresponding to each other, depending on the specifications of the camera lens assembly. Further, if necessary, other lenses or all of the lenses may also be coupled in coupling structures corresponding to each other.

In particular, as shown in FIG. 3, since the radius R of curvature of the coupling portion of the front lens and the angle V of the apex of the coupling groove of the rear lens satisfy R>0.05 mm and 60°<V<120°, it is possible to prevent eccentricity of optical axes and tiltering and it is also possible to improve precision of assembly.

In FIG. 3, the front lens is the first lens 100, the rear lens is the second lens 200, a first coupling portion 120 is formed at the first lens, and a first coupling groove 210 is formed at the second lens.

The angle of the apex of the first coupling groove 210 is the angle at the point where lines extending from two surface (or two lines) facing each other of the first coupling groove 210 intersect.

When the radius of curvature of the coupling portion of the front lens is smaller than 0.05 mm or the angle of the apex of the coupling groove of the rear lens is smaller than 60° or larger than 120°, a gap is generated between two combined lenses, so eccentricity and tiltering may be generated. Further, unstable coupling is caused such as surface contact or linear contact of the coupling portion and the coupling groove of two combined lenses or point contact with the coupling groove at both sides of the coupling portion at a too short distance, so it is difficult to prevent eccentricity and tiltering.

Accordingly, the coupling portion of the front lens and the coupling groove of the rear lens which have coupling structures corresponding to each other should be in point contact with each other, and the radius R of curvature of the coupling portion of the front lens and the angle V of the apex of the coupling groove of the rear lens should satisfy R>0.05 mm and 60°<V<120° so that the point contact positions are spaced a predetermined distance and a stable coupling structure is induced.

As an embodiment of the present disclosure, the front lens is the first lens 100 positioned at an object and the rear lens is the second lens 200 positioned behind the first lens 100. The embodiment includes a first lens 100 having a first coupling portion 120 outside the effective diameter on the rear surface and a second lens 200 having a first coupling groove 210, which is coupled to the first coupling portion 120, outside the effective diameter on the front surface and combined with the first lens 100 with the optical axes aligned.

That is, according to an embodiment of the present disclosure, the first lens 100 and the second lens 200 from the front of the lens barrel 10 are most sensitive to eccentricity between lenses. Accordingly, the shapes of the first lens 100 and the second lens 200 are improved so that the optical axes can be naturally aligned when the lenses are assembled in the lens barrel 10 in an embodiment of the present disclosure.

As described above, the coupling portion of the first lens 100 and the coupling groove of the second lens 200 should be in point contact with each other, and the radius R of curvature of the coupling portion of the first lens 100 and the angle V of the apex of the coupling groove of the second lens 200 should satisfy R>0.05 mm and 60°<V<120° so that the point contact positions are spaced a predetermined distance and a stable coupling structure is induced and maintained.

According to an embodiment of the present disclosure, the coupling portion has a radius of curvature R>0.05 mm and has a smooth curved shape, the angle V of the apex of the coupling groove satisfies 60°<V<120°, and a non-contact region exists between the coupling surfaces of the coupling portion and the coupling groove.

That is, according to the present disclosure, the coupling portion and the coupling portion are in point contact with each other with a non-contact region therebetween, thereby inducing a more stable coupling structure.

Since the first lens 100 and the second lens 200 are combined through point contact, as described above, they are accurately combined at exact positions through point contact. Accordingly, when the second lens 200 is coupled to the first lens 100, the second lens 200 is combined with the first lens 100 with the optical axis naturally aligned without eccentricity.

If the second lens 200 and the third lens 300 have a coupling portion (second coupling portion 220) and a coupling groove (second coupling groove 310) in the same way, when the third lens 300 is coupled to the second lens 200, the third lens 300 is combined with the second lens 200 with the optical axis naturally aligned without eccentricity.

Further, if the third lens 300 and the fourth lens 400 have a coupling portion (third coupling portion 320) and a coupling groove (second coupling groove 410) in the same way, when the fourth lens 400 is coupled to the third lens 300, the fourth lens 300 is combined with the third lens 300 with the optical axis naturally aligned without eccentricity.

FIGS. 4 to 7 show the shapes of a first lens to a fourth lens according to an embodiment of the present disclosure.

FIG. 4 is a schematic view of a first lens according to an embodiment of the present disclosure, FIG. 5 is a schematic view of a second lens according to an embodiment of the present disclosure, FIG. 6 is a schematic view of a third lens according to an embodiment of the present disclosure, and FIG. 7 is a schematic view of a fourth lens according to an embodiment of the present disclosure.

As shown in the figures, a first coupling portion 120 is formed at the first lens 100, a first coupling groove 210 and a second coupling portion 220 are formed at the second lens 200, a second coupling groove 310 and a third coupling portion 320 are formed at the third lens 300, and a third coupling groove 410 is formed at the fourth lens 400, whereby the lenses are assembled with the optical axes naturally aligned by coupling the first coupling portion 120 and the first coupling groove 210, the second coupling portion 220 and the second coupling groove 210, and the third coupling portion 320 and the third coupling groove 410, respectively.

Since the rear lens and the front lens are combined through point contact by the structures of the coupling portion and the coupling groove, as described above, it is possible to minimize the problem of rebound of the front lens when the rear lens is assembled after the front lens is assembled, whereby the lenses are easily assembled with the optical axes aligned.

FIGS. 8 to 19 show the shapes of coupling portions formed at a front lens in accordance with an embodiment of the present disclosure, in which the hatched portions are the coupling portions protruding at the edge portion on the rear surface of the front lens. The first coupling portion 120 of the first lens 100 (the coupling portion formed at the front end) is shown as an embodiment in FIGS. 8 to 10.

According to the embodiment of FIG. 8, the coupling portion formed at the front lens has a circular annular shape formed along the outside of the effective diameter and the coupling groove of the rear lens is also formed in a circular annular shape along the outside of the effective diameter to correspond to the coupling portion.

According to an embodiment of the present disclosure, the coupling portion protruding outside the effective diameter on the rear surface of the first lens 100 has a circular annular shape formed along the outside of the effective diameter, and the coupling groove that is formed outside the effective diameter on the front surface of the second lens 200 and is coupled to the coupling portion is also formed in a circular annular shape along the outside of the effective diameter, whereby a more stable coupling structure is induced and the optical axes are aligned.

Further, as shown in FIGS. 9 and 10, as another embodiment of the present disclosure, one or more coupling portions and coupling grooves may be formed at predetermined positions along the outside of the effective diameters of the front lens and the rear lens, depending on the specifications of products.

That is, as shown in FIGS. 9 and 10, coupling portions and coupling grooves are formed at specific positions along the outside of the effective diameters, whereby a more stable coupling structure is induced and maintained.

In particular, the coupling portion and the coupling groove may be symmetrically formed with the center of the lens therebetween, and the shapes, positions, and numbers of the coupling grooves and coupling portions may be optimally designed in consideration of the specifications of products, the shapes of lenses, or the like.

Since a coupling portion and a coupling groove are formed along the outside of an effective diameter, stress that may be generated when lenses are combined does not influence the effective diameter region, which is suitable for providing a high-resolution camera lens assembly.

Meanwhile, an optical path blocking film 700 may be inserted, except for the effective diameter region, between the front lens and the rear lens of the camera lens assembly according to the present disclosure. This is for preventing deterioration of performance by blocking inflow of surrounding beams and for blocking unnecessary light such as a flare.

Further, according to the present disclosure, the inner side of the barrel 10 and the outer sides of lenses are fitted such that optical axes are aligned. That is, the optical axes of the first lens 100, etc. are naturally aligned while eccentricity of the lenses to the barrel 10 is adjusted.

According to the present disclosure, since a coupling portion and a coupling groove are formed along the outside of an effective diameter, when lenses are assembled in the barrel 10, the lenses or the optical axes of the lenses in the barrel 10 are aligned while the assembly force (force pushed by the barrel 10, elasticity generated by the coupling portions and the coupling grooves of the lenses) is balanced.

As described above, since the optical axes of lenses are naturally aligned by the shapes of the lenses in the present disclosure, eccentricity is adjusted and optical axes are aligned through only the operation of assembling lenses in a barrel without a specific component for adjusting eccentricity. Accordingly, it is possible to simply align the optical axes of lenses or the optical axis of a single lens.

What is claimed is:

1. A self-aligning camera lens assembly in which a plurality of lenses is assembled in a lens barrel, the self-aligning camera lens assembly comprising:
a front lens having a coupling portion formed outside an effective diameter on a rear surface thereof; and
a rear lens positioned behind the front lens, having a coupling groove formed outside an effective diameter on a front surface thereof to be coupled to the coupling portion, and combined with the front lens with optical axes aligned,
wherein a radius (R) of curvature of the coupling portion of the front lens and an angle (V) of an apex of the coupling groove of the rear lens satisfy R>0.05 mm and 60°<V<120°.

2. The self-aligning camera lens assembly of claim 1, wherein the coupling portion and the coupling groove are coupled to each other through point contact.

3. The self-aligning camera lens assembly of claim 1, wherein the front lens is a first lens positioned at an object and the rear lens is a second lens positioned behind the first lens, the self-aligning camera lens assembly comprising:
a first lens having a first coupling portion outside an effective diameter on a rear surface thereof; and
a second lens positioned behind the first lens, having a first coupling groove, which is coupled to the first coupling portion, outside an effective diameter on a front surface thereof and combined with the first lens with optical axes aligned.

4. The self-aligning camera lens assembly of claim 1, wherein the coupling portion of the front lens and the coupling groove of the rear lens are selectively formed up to a specific lens or are formed at all lenses, depending on specifications of the camera lens assembly.

5. The self-aligning camera lens assembly of claim 1, wherein the coupling portion of the front lens and the coupling groove of the rear lens are each formed in a circular annular shape along an outside of an effective diameter.

6. The self-aligning camera lens assembly of claim 1, wherein the coupling portion of the front lens and the coupling groove of the rear lens are each formed at one or more positions along an outside of an effective diameter.

7. The self-aligning camera lens assembly of claim 1, wherein a non-contact region exists between coupling surfaces of the coupling portion and the coupling groove.

8. The self-aligning camera lens assembly of claim 1, wherein an inner side of the barrel and an outer side of a lens are fitted to each other such that optical axes are aligned.

9. The self-aligning camera lens assembly of claim 1, wherein a light path blocking film is inserted between the front lens and the rear lens.

10. The self-aligning camera lens assembly of claim 1, wherein the camera lens assembly includes four to seven lenses.
